(19) United States
(12) Patent Application Publication
(10) Pub. No.: US 2010/0047038 A1
(43) Pub. Date: Feb. 25, 2010

(54) Bolt protectors for subsurface pipe fittings and associated methods

(76) Inventor: James V. Brimhall, Herriman, UT (US)

Correspondence Address: THORPE NORTH & WESTERN, LLP., P.O. Box 1219, SANDY, UT, 84091-1219, US

(21) Appl. No.: 12/229,510

(22) Filed: Aug. 21, 2008

(51) Int. Cl. F16B 37/00

(52) U.S. Cl. 411/428

(57) ABSTRACT

A protective covering for protecting an exposed portion of a threaded fastener comprises a body cavity, sized and shaped to be positioned over the exposed portion of the threaded fastener. The body cavity includes at least two ends and a quantity of a protectant material is disposed within the body cavity. A rupturable membrane is disposed over at least one end of the body cavity. The rupturable membrane operable to: retain the protectant material within the body cavity during storage and transport of the protective covering, and be ruptured during positioning of the body cavity over the exposed portion of the threaded fastener.

### FIELD OF THE INVENTION

The present invention relates generally to systems used in installing pipe assemblies intended for use below ground level, or underwater. More particularly, the present invention relates to systems for protecting threaded fasteners used in such pipe assemblies from the detrimental effects of exposure to earthen materials, moisture and other potentially harmful materials.

### BACKGROUND OF THE INVENTION

The use of threaded fasteners is common in subsurface pipe installations. Numerous threaded fastening systems have been developed and successfully utilized over the years to connect pipes and pipe fittings one to another. Many times, such systems are installed and then covered (e.g., buried) by earthen fill materials, water or combinations of the two. Such systems should be capable of existing while covered with earth or water for many years without requiring routine maintenance. However, as the threaded fastening systems utilized in such installations are typically formed from metallic materials, such exposure can significantly compromise the longevity and structural integrity of these installations.

### BRIEF DESCRIPTION OF THE DRAWINGS

FIG. 1 is a perspective view of a protective covering in accordance with an embodiment of the invention;

FIG. 2A is a side, partially sectioned view of an assembly utilizing a male and female fastener;

FIG. 2B is a side, partially sectioned view of the assembly of FIG. 2A, shown with the protective covering of FIG. 1 installed thereon; and

FIG. 3 is a schematic view of an exemplary assembly including a plurality of fasteners each coverable by a protective covering of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “protective covering” can include one or more of such coverings.

### Definitions

In describing and claiming the present invention, the following terminology will be used in accordance with the definitions set forth below.

As used herein, the term “food-grade” is to be understood to refer to a material that has been certified as safe for use in applications where contact with food may be possible. Examples of food-grade lubricants include, without limitation, lubricants that qualify as USDA H1 and H3 lubricants; lubricants that meet DIN standard V 0010517, 2000-08; and lubricants that meet NSF 116-20000 Draft Standard (this definition applies to the content of these standards as of the date of filing of this application).

As used herein, the term “subsurface” is to be understood to refer to an application that exists primarily beneath some type of covering material, such as earthen materials, water and the like. Typically, such installations are assembled while not submerged under or covered by materials, and are then later covered with earth, water, etc.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

Invention

The present invention provides protective coverings for use in protecting otherwise exposed portions of fasteners, including threaded fasteners such as bolts, nuts, screws, etc., used in subsurface applications. For example, the coverings can be used to protect exposed portions of threaded fasteners used in coupling subsurface water lines and the like one to another. The present invention can advantageously limit or prevent corrosion of the threaded fasteners over time after the fasteners are covered by earth or water.

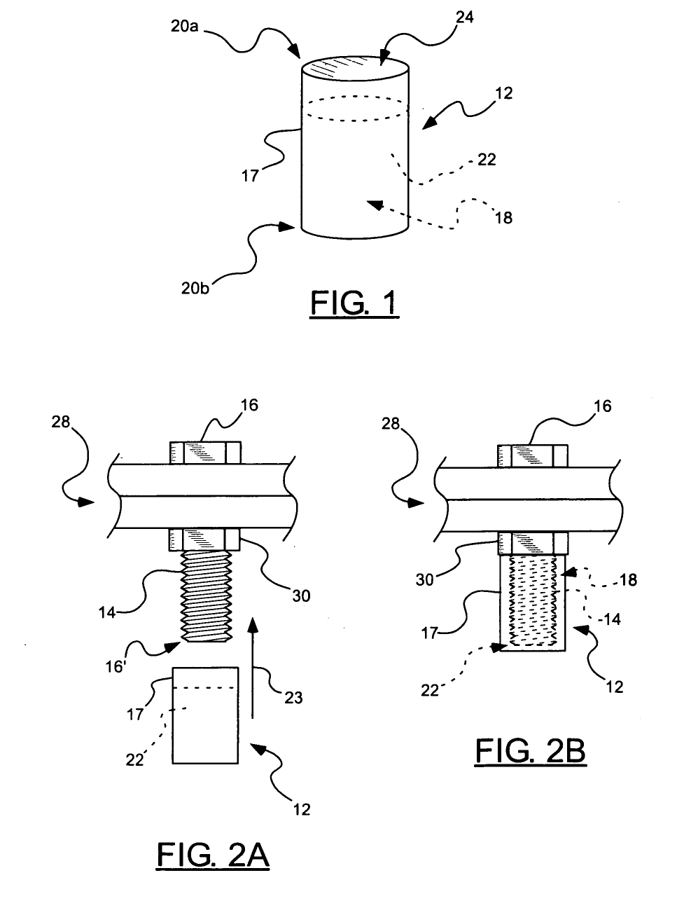

As illustrated by example in FIGS. 1, 2A and 2B, in accordance with one embodiment of the invention, a protective covering 12 is provided for protecting an otherwise exposed portion 14 of a threaded fastener 16. The covering 12 can include a body 17 having a body cavity 18 that can be sized and shaped to be positioned over the exposed portion of the threaded fastener. Generally, the body can include at least two ends 20a, 20b. A quantity of a protectant material 22 (generally a lubricant) can be disposed within (e.g., held by) the body cavity.

In the aspect of the invention shown in FIG. 1, a rupturable membrane 24 can be disposed over at least one end (in this case, end 20a) of the body 17. The rupturable membrane can be operable to retain the protectant material 22 within the body cavity 18 during storage and transport of the protective covering 12. During application (or positioning) of the body cavity over the otherwise exposed portion 14 of the threaded fastener 16, the rupturable membrane is configured to be ruptured to allow the body cavity to be installed over the threaded fastener with minimal force.

In a typical application, a user will generally position the protective covering 12 adjacent the exposed portion 14 of the fastener 16, as shown in FIG. 2A. The user can then move the protective covering as indicated by the directional indicator 23 of FIG. 2A such that membrane 24 contacts the distal end 16′ of the fastener 16. As the protective covering is forced over the distal end of the fastener, the membrane rupture and allows the body cavity 18 to be positioned around the exposed portion of the fastener, resulting in substantially all of the exposed portion being covered by the protectant material 22. The protective covering can then be covered by earthen materials or water (not shown) and remain serviceable for many years. While not so required, in one embodiment, the end (20b, for example) of the body 17 opposite the end (20a, for example) installed over the fastener can be closed so as to avoid breakage of this distal end after application of the protective covering over the fastener.

The rupturability of the membrane 24 can be provided in a number of manners. In one aspect, the rupturable membrane is formed from a polymer film having a thickness in the range of about 0.0005 inches to about 0.010 inches. In one aspect, the film has a thickness of about 0.006 inches. In this manner, the membrane is sufficiently tough so as to resist premature breakage while the protective coverings 12 are stored, shipped or handled, and yet can be relatively easily broken as the covering is forced over the end of a relatively rigid fastener.

The membrane 24 can be attached to the body 17 in a number of manners. In one aspect, the membrane can be plastically welded about the rim of the end 20a of the body. In another aspect, the membrane can be bonded to the rim. The membrane can also be wrapped downwardly around the rim and sides of the body and thereby be attached to the body below the rim. Adhesive tape can also be used to attach the membrane to the body, as can a variety of attachment mechanisms known to those of ordinary skill in such arts. In one aspect of the invention, depending upon the thickness and strength of the membrane, slight cuts or thin portions (not shown) may be formed in the membrane to increase the ease of rupture of the membrane.

While the material from which the body can be formed can vary, in one aspect of the invention the body is formed of a relatively pliable but tough material, such as a high density polyethylene (HDPE) sold under the tradename Petrothene LR 7340-01. Other suitable materials are sold under the tradenames Alathon and Forar.

The protective coverings 12 can be used in a variety of applications and with a variety of different pipe fitting shapes, sizes and designs. The example illustrated in FIGS. 2A and 2B include a standard male bolt fastener 16 which is passed through holes (not shown) in exemplary fitting components 28. Threaded female fastener (e.g., nut) 30 is tightened upon a male fastener to secure the components 28 in a fixed relationship. The fitting components illustrated in the figures are used for explanatory purposes only, and are not meant to limit the invention to any particular pipe, coupling or fitting application.

In one aspect of the invention, the body cavity 18 can include an internal diameter that is larger than an external diameter of the otherwise exposed portion 14 of the threaded fastener. This relationship is illustrated in FIG. 2B, where it will be appreciated that a quantity of the protectant material 22 will remain in the body cavity 18 after the protective covering 12 is installed over the fastener. Thus, the body cavity is sufficiently large so as to easily accommodate the otherwise exposed portion of the male fastener 16: yet is sufficiently small so as to abut against female threaded fastener 30. In this manner, coverage of the male threads can be obtained without requiring excessive amounts of protectant material 22. In one embodiment, the available storage volume of the body cavity can range from about 0.125 in³ to about 3.0 in³. In one embodiment, the available storage volume can range from about 0.25 in³ to about 1.5 in³.

The protectant material 22 can advantageously be selected to minimize adverse risks associated with conventional lubricants when used in applications involving potable water supplies (or in applications where contamination of ground water is a concern). In one aspect, the protectant material comprises a food-grade lubricant. One example of a suitable food-grade lubricant includes, without limitation, a lubricant sold under the tradename Chevron FM Grease. In another aspect of the invention, the protectant material can comprise a biodegradable lubricant. By utilizing such lubricants, the risk of contaminating water supplies, either through direct contamination, or indirect ground contamination through earthen materials, can be minimized.

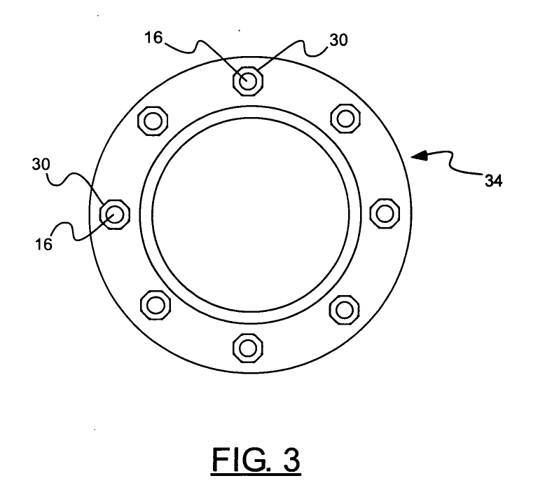

FIG. 3 illustrates an exemplary application of one embodiment of the invention in which a fastener kit can be provided to enable use of the present invention with a typical pipe coupling assembly 34. In this embodiment, a plurality of protective coverings (8 total would be required, not shown in this view) can be provided in a package (not shown) with a plurality of male threaded fasteners 16 and a plurality of female threaded fasteners 30. In use, a pipe fitter would assemble the coupling assembly as is required by the job at hand. After the assembly is completed, the pipe fitter would then install each of 8 protective coverings 12 (not explicitly shown in this view) over each of the male fasteners 16 protruding through the female fasteners. The entire assembly could then be covered in earth or other fill material, and the fasteners could exist for many years without corroding or otherwise becoming damaged.

In addition to the structural features outlined above, the present invention also provides a method of protecting exposed portions of fasteners used in subsurface connections, comprising: positioning a protective covering adjacent an exposed portion of a threaded fastener, the protective covering having a body cavity defined therein, the body cavity holding a quantity of protectant material; forcing the protective covering over the exposed portion of the threaded fastener to thereby: displace a portion of the protectant material from the body cavity; and coat the exposed portion of the threaded fastener with the protective covering.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. A protective covering for protecting an exposed portion of a threaded fastener, comprising:
a body cavity, sized and shaped to be positioned over the exposed portion of the threaded fastener, the body cavity including at least two ends;
a quantity of a protectant material, disposed within the body cavity;
a rupturable membrane, disposed over at least one end of the body cavity, the rupturable membrane operable to:
i) retain the protectant material within the body cavity during storage and transport of the protective covering, and
ii) be ruptured during positioning of the body cavity over the exposed portion of the threaded fastener.

2. The protective covering of claim 1, wherein the rupturable membrane comprises a polymer film having a thickness of about 0.010 inches or less.

3. The protective covering of claim 1, wherein the protectant material comprises a food-grade lubricant.

4. The protective covering of claim 1, wherein the protectant material comprises a biodegradable lubricant.

5. The protective covering of claim 1, wherein the body cavity includes an internal diameter larger than an external diameter of the exposed portion of the threaded fastener.

6. The protective covering of claim 1, further comprising a plurality of threaded fasteners and a corresponding plurality of protective coverings provided in a kit.

7. The protective covering of claim 1, wherein the body cavity defines a storage volume from about 0.25 in³ to about 1.50 in³.

8. A kit for use in coupling together two or more components configured for use in a subsurface environment, comprising:
a plurality of threaded male fasteners; and
a plurality of protective coverings for protecting exposed portions of the threaded male fasteners, the protective coverings each including:
a body cavity, sized and shaped to be positioned over the exposed portion of the threaded male fastener;
a quantity of a protectant material, disposed within the body cavity, the protectant material comprising a food-grade lubricant.

9. The protective covering of claim 8, further comprising a rupturable membrane, disposed over at least one end of the body cavity, the rupturable membrane positioned to:
i) retain the protectant material within the body cavity during storage and transport of the protective covering, and
ii) be ruptured upon positioning of the body cavity over the exposed portion of the male threaded fastener.

10. The protective covering of claim 9, wherein the rupturable membrane comprises a polymer film having a thickness of about 0.010 inches or less.

11. The protective covering of claim 8, wherein the body cavity includes an internal diameter larger than an external diameter of the exposed portion of the threaded male fastener.

12. The protective covering of claim 9, wherein the body cavity defines a storage volume from about 0.25 in³ to about 1.50 in³.

13. A method of protecting exposed portions of fasteners used in subsurface connections, comprising:
positioning a protective covering adjacent an exposed portion of a threaded fastener, the protective covering having a body cavity defined therein, the body cavity holding a quantity of protectant material;
forcing the protective covering over the exposed portion of the threaded fastener to thereby:
displace a portion of the protectant material from the body cavity; and
coat the exposed portion of the threaded fastener with the protective covering.

14. The method of claim 13, wherein the protectant material comprises a food-grade lubricant.

15. The method of claim 13, wherein the protectant material comprises a biodegradable lubricant.

16. The method of claim 13, wherein the protective covering includes a rupturable membrane attached to an end thereof; and
wherein forcing the protective covering over the exposed portion of the threaded fastener results in rupturing of the membrane.

17. The method of claim 16, wherein the rupturable membrane comprises a polymer film having a thickness of about 0.010 inches or less.

18. The method of claim 13, wherein the body cavity is defined by a substantially pliable polymer material.

19. The method of claim 13, wherein the body cavity defines a storage volume from about 0.25 in³ to about 1.50 in³.
